(19) United States
(12) Patent Application Publication
(10) Pub. No.: US 2002/0141187 A1
(43) Pub. Date: Oct. 3, 2002

(54) Decorative base for a christmas tree

(76) Inventor: Chung-Kuei Lin, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/803,961

(22) Filed: Mar. 13, 2001

(51) Int. Cl. F21V 1/00; F16M 13/00

(52) U.S. Cl. 362/284; 248/519

(57) ABSTRACT

A decorative base for a Christmas tree has a rotating base, a lampshade mounted on the rotating base, and a tube containing water set on the lampshade. The rotating base has a chamber, and several devices, such as a colorful illuminating device, a bubble generating device, and a music outputting device. When the decorative base is in operation, the colorful illuminating device generates light with different colors passed into the tube, and the bubble generating device inputs air into the water of the tube so as to make bubbles. Furthermore, ornaments are set on the outer periphery of the rotating base so as to enhance the rotating decorative effect.

### BACKGROUND OF THE INVENTION

1. Field of the Invention

The present invention relates to a decorative base for a Christmas tree, and more particularly to a decorative base having a colorful illuminating device, a bubble generating device, a rotatable base having decoration and a music outputting device to enhance a decorative effect of the Christmas tree.

2. Description of Related Art

The use of ornamental and decorative accessories during holiday seasons, such as Christmas Day, is established in the art. A “Christmas tree” is the most common and traditional item that is used by people. Such trees are often decorated with ornaments, lights, tinsel, etc., to increase the decorative effect thereof. However, there are several problems related to the use of real (live) trees. The real tree is cut and utilized for only a short period of time and then subsequently discarded. That is to say, it is a waste of natural resources. Further, people need to annually spend time to decorate the real tree and store the decorative accessories after the holiday season has passed.

Thus, those real trees are gradually being replaced by artificial decorative trees due to the convenience and benefit to the environment. However, those artificial decorative trees only have some ornamental accessories placed thereon, and thus they quickly appear to be static and uninteresting.

To overcome these shortcomings, the present invention tends to provide a decorative base for a Christmas tree to mitigate and obviate the aforementioned problems.

### SUMMARY OF THE INVENTION

The main objective of the invention tends to provide a decorative base for a Christmas tree, wherein the decorative base comprises a colorful illuminating device, a bubble generating device, a rotatable base having decorations and a music generating unit to increase decorative effect.

Other objects, advantages and novel features of the invention will become more apparent from the following detailed description when taken in conjunction with the accompanying drawings.

### BRIEF DESCRIPTION OF THE DRAWINGS

FIG. 1 is a partial cross-sectional view of a tube mounted on a decorative base in accordance with the present invention;

FIG. 2 is a cross sectional view taken from line 2—2 shown in FIG. 1 in accordance with the present invention;

FIG. 3 is a partial cross side sectional view of FIG. 1 in accordance with the present invention;

FIG. 4 is a plan view of a disk in accordance with the present invention, wherein the disk has variety of colored regions indicated by the letters A, B, C, and D; and

FIG. 5 is a partial perspective view showing ornaments on the decorative base.

### DETAILED DESCRIPTION OF THE PREFERRED EMBODIMENT

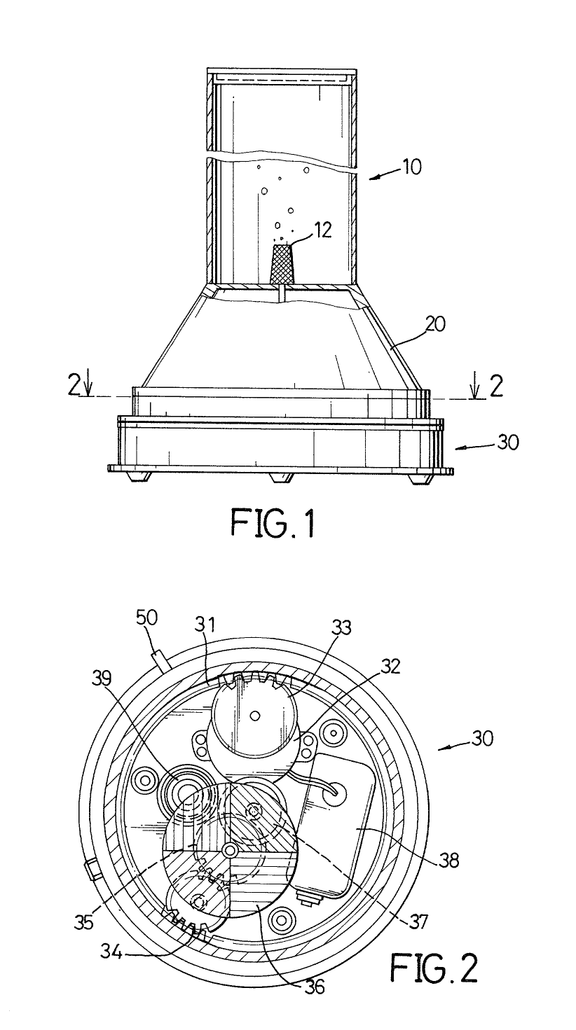

With reference to FIG. 1, a tube (10) is set on a lampshade (20), wherein a first end of the tube (10) is sealed by a cover that has a hole defined therein. An interior of the tube (10) contains water. An air nozzle (12) is set at a second end of the tube (10) to communicate with the interior of the tube (10) and is connected to an air pump (38), shown in FIG. 2, via a hose. The lampshade (20) is mounted on a base (30) that has a chamber.

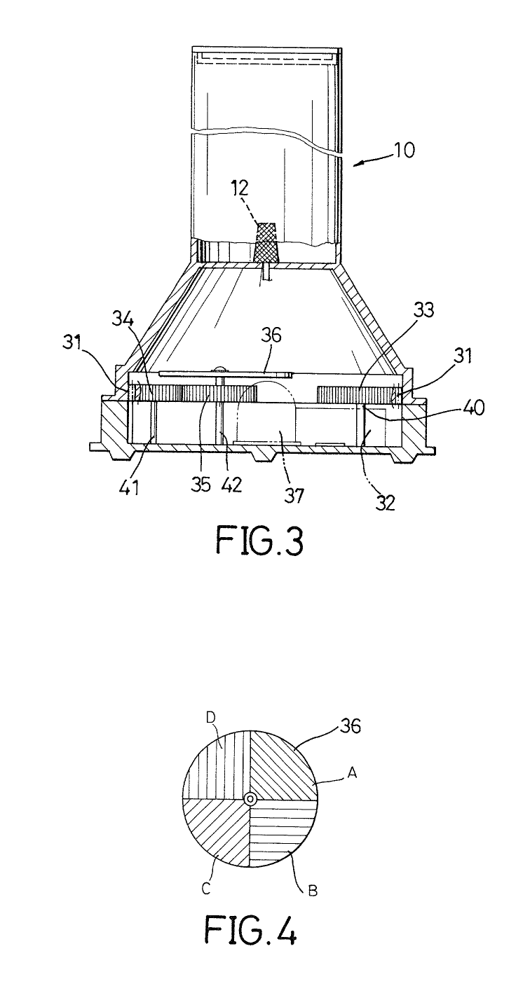

With reference to FIGS. 2 and 3, a first gear (31) is formed on an inner periphery of the base (30) for transmitting the base (30) and other gears to rotate. In the chamber, a motor (32) is located on a bottom of the base (30). A second gear (33) is rotatably mounted on a first shaft (40) of the motor (32) and smoothly meshes with the first gear (31). A third gear (34) mounted on a second shaft (41) that securely connects with the bottom of the base (30) is meshed with the first gear (31). The third gear (34) also meshes with a fourth gear (35) that is mounted on a third shaft (42). A first end of the third shaft (42) is securely mounted on the bottom of the base (30), and a disk (36) is rotatably mounted on a second end of the third shaft (42). The disk (36) is formed of transparent or translucent material comprised of many colored regions, such as A, B, C and D regions that are shown in FIG. 4. Further, the disk (36) is set above the fourth gear (35), and driven or transmitted by the fourth gear (35). A lamp (37) is suitably positioned on the bottom of the base (30) so that light emitted from the lamp (37) passes through the disk (36) and into the tube (10). The air pump (38) is set on the bottom of the base (30) and connected with the air nozzle (12) via the hose. Furthermore, a speaker (39) is set on the bottom of the base (30) and electrically connected with a music IC that is mounted on a circuit board (not shown). A switch (50) is set on the base (30) to actuate the motor (32).

When the switch (50) is turned on, the motor (32) begins to operate and transmit or drive the first shaft (40) to rotate the second gear (33) and the base (30), whereby the first gear (31) starts to rotate due to the rotation of the second gear (33). Once the first gear (31) rotates, the third gear (34) also synchronously rotates, whereby the fourth gear (35) begins to rotate. Once the fourth gear (35) starts to rotate and transmit the disk (36) to rotate, light emitted from the lamp (37) is passed through the colored regions of the disk (36), thus light with different colors is passed into the tube (10) to provide a special decorative effect. Meanwhile, the air pump (38) generates and inputs air into to the tube (10) from the nozzle (12), thus bubbles are generated in the tube (10) to provide decorative bubbling effect, wherein the hole defined in the cover is used to balance air presure between the interior of the tube (10) and an exterior of the tube (10). Furthermore, the speaker (39) outputs music to increase the overall decorative effect of the invention.

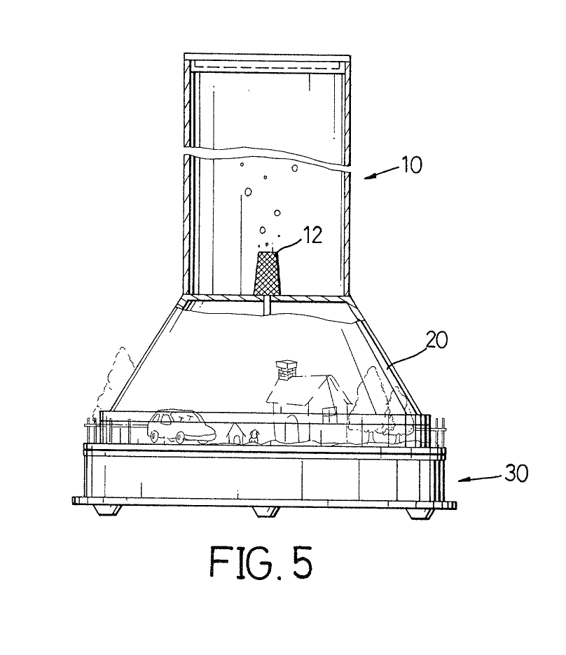

With reference to FIG. 5, in order to enhance the variety of decorative effects, ornaments are set at the outer periphery of the base (30), and those ornaments also rotate due to the rotating base (30).

Although the present invention has been explained in relation to its preferred embodiment, it is to be understood that many other possible modifications and variations can be made without departing from the spirit and scope of the invention as hereinafter claimed.

What is claimed is:

1. A decorative base for a Christmas tree comprising:
a base having a chamber therein;
a lampshade mounted on the base;
a motor placed in the chamber for driving a second gear mounted on a first shaft of the motor, wherein the second gear is meshed with a first gear so that the second gear is able to drive the first gear to rotate; wherein the first gear is formed in an inner periphery of the base in order to rotate the base;
a third gear meshed with the first gear and rotatably mounted on a free end of a second shaft that is securely formed and extended out from the chamber so that the third gear is able to be driven by the first gear;
a third shaft securely formed and extended out from the chamber;
a fourth gear rotatably mounted on the third shaft and meshed with the third gear so that the fourth gear is able to be driven by the third gear;
a disk rotatably mounted on a free end of the third shaft; and
a lamp positioned in the chamber so that light from the lamp passes through the disk.

2. The decorative base as claimed in claim 1 further comprising:
a tube having a first end covered by a cover that has a hole defined therein for balancing air pressure, wherein a second end of the tube is sealingly mounted above the lampshade, and the tube is full of water; and
a nozzle peripherally formed on the tube to communicate with an interior of the tube and connected to an air pump positioned in the chamber via a hose,
wherein the air pump generates bubbles in the water of the tube to provide a decorative bubbling effect.

3. The decorative base as claimed in claim 2, wherein a speaker is placed in the chamber and electrically connected with a music IC that is mounted on a circuit board, the speaker outputs sounds to enhance a decorative effect.

4. The decorative base as claimed in claim 3, wherein the disk is formed of translucent material composed of colored regions so that light emitted from the lamp has different colors variation.

5. The decorative base as claimed in claim 3, wherein ornaments are attached at an outer periphery of the base so as to enhance the decorative effect of the decorative base.

6. The decorative base as claimed in claim 4, wherein ornaments are attached at an outer periphery of the base so as to enhance the decorative effect of the decorative base.
